(19) United States
(12) Patent Application Publication
(10) Pub. No.: US 2013/0174807 A1
(43) Pub. Date: Jul. 11, 2013

(54) ELECTRIC ACTUATOR FOR VEHICLE

(71) Applicant: DENSO CORPORATION, Kariya-city (JP)

(72) Inventors: Hiroyuki KADO, Kariya-city (JP); Taisuke MURATA, Obu-city (JP); Yoshiyuki OKUBO, Yokkaichi-city (JP); Yoshiyuki KONO, Obu-city (JP)

(73) Assignee: DENSO CORPORATION, Kariya-city (JP)

(21) Appl. No.: 13/737,547

(22) Filed: Jan. 9, 2013

(30) Foreign Application Priority Data
Jan. 10, 2012 (JP) 2012-2124

(51) Int. Cl. F02D 45/00

(52) U.S. Cl. CPC F02D 45/00
USPC 123/399

(57) ABSTRACT

A speed-reducing-gear device includes a plurality of gears, which are arranged to amplify rotational force received from an electric motor. A face width of a plurality of external teeth, which are circumferentially placed one after another in a toothed section of a final gear among the plurality of gears, varies in a rotational direction of the final gear, and the face width is measured in an axial direction of the final gear.

### CROSS REFERENCE TO RELATED APPLICATION

This application is based on and incorporates herein by reference Japanese Patent Application No. 2012-002124 filed on Jan. 10, 2012.

### TECHNICAL FIELD

The present disclosure relates to an electric actuator for a vehicle.

### BACKGROUND

A known electric actuator includes an electric motor and a speed-reducing gear device. The electric motor generates a rotational force upon energization of the electric motor. The speed-reducing-gear device includes a plurality of gears, which are arranged to amplify the rotational force received from the electric motor. One example of such as an electric actuator is known as an electric actuator of an electronic throttle apparatus (see JP2005-299413A).

A final gear (an example of a subject gear among a plurality of gears) of the speed-reducing-gear device of JP2005-299413A will be described with reference to FIGS. 10A and 10B.

The final gear 105 of JP2005-299413A is made of a resin material to reduce the weight of the final gear 105 and thereby to reduce the costs. As shown in FIG. 10A, external teeth 106 are provided only in a toothed section 200 of the final gear 105, which corresponds to a rotatable range of the final gear 105 that coincides with a rotatable range of a throttle valve. A face width α of the external teeth 106, which is measured in an axial direction of the final gear 105, is constant throughout an entire circumferential extent of the toothed section 200, as shown in FIG. 10B.

For instance, when the face width α of the external teeth 106 is made small, the wearing resistance of the external teeth 106 is deteriorated.

In contrast, when the face width α of the external teeth 106 is made large, the slide loss (gear mesh loss) is generated at the contact between the corresponding external tooth 106 of the final gear 105 and a corresponding one of teeth of a mating gear, which contact with each other. This may result in deterioration in precision control of the drive subject (e.g., the throttle valve) and/or may result in interference with another component.

Alternatively, the weight balance of the final gear 105 may be deteriorated due to an influence of, for example, stoppers provided in the final gear 105.

### SUMMARY

The present disclosure is made in view of the above disadvantages. According to the present disclosure, there is provided an electric actuator for a vehicle, including an electric motor and a speed-reducing-gear device. The electric motor generates a rotational force upon energization of the electric motor. The speed-reducing-gear device includes a plurality of gears, which are arranged to amplify the rotational force received from the electric motor. A face width of a plurality of external teeth, which are circumferentially placed one after another in a toothed section of at least one subject gear among the plurality of gears, varies in a rotational direction of the at least one subject gear. The face width is measured in an axial direction of the at least one subject gear.

### BRIEF DESCRIPTION OF THE DRAWINGS

The drawings described herein are for illustration purposes only and are not intended to limit the scope of the present disclosure in any way.

FIG. 1 is a cross sectional view of an electronic throttle apparatus according to a first embodiment of the present disclosure;

FIG. 2A is a front view of a final gear of a speed-reducing-gear device of an electric actuator according to the first embodiment;

FIG. 2B is a side view of the final gear of FIG. 2A;

FIGS. 3A and 3B are schematic diagrams showing two operational states, respectively, of the final gear of the first embodiment;

FIG. 4 is a diagram showing a relationship between a rotational angle of a shaft and a shaft torque applied from a spring device to the shaft according to the first embodiment;

FIG. 5 is a side view of a final gear according to a second embodiment of the present disclosure;

FIG. 6A is a front view of a final gear according to a third embodiment of the present disclosure;

FIG. 6B is a side view of the final gear of FIG. 6A;

FIG. 7 is a side view of a final gear according to a fourth embodiment of the present disclosure;

FIGS. 8A to 8C are schematic diagrams showing three operational states, respectively, of a final gear according to a fifth embodiment of the present disclosure;

FIG. 9 is a side view of the final gear of the fifth embodiment;

FIG. 10A is a front view of a final gear of a prior art; and

FIG. 10B is a side view of the final gear of FIG. 10A.

### DETAILED DESCRIPTION

Various embodiments of the present disclosure will be described with reference to the accompanying drawings. The following embodiments are mere examples of the present disclosure, and the present disclosure is not limited to the following embodiments.

### First Embodiment

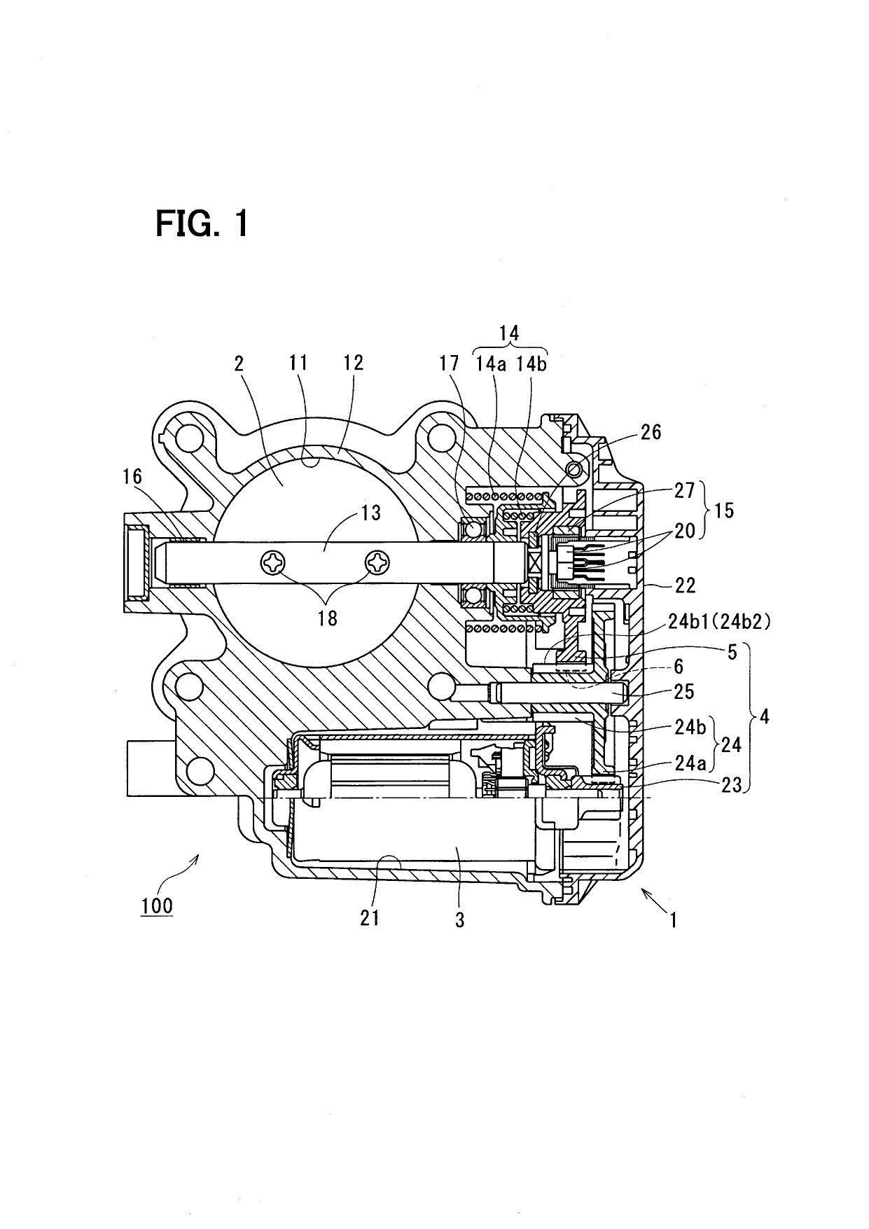

A first embodiment of the present disclosure will be described with reference to FIGS. 1 to 4.

An electric actuator 1 of the present embodiment is installed in an electronic throttle apparatus 100 of a vehicle (e.g., an automobile).

The electronic throttle apparatus 100 adjusts a quantity of intake air drawn into an internal combustion engine of the vehicle. The electronic throttle apparatus 100 is installed in an intake conduit, which forms an intake passage 11 to conduct intake air, at a location between an air cleaner and an intake manifold.

The electronic throttle apparatus 100 includes a housing 12, a shaft 13, a throttle valve 2 and the electric actuator 1. The housing 12 forms a portion of the intake passage 11 of the intake conduit, which conducts the intake air to the internal combustion engine. The shaft 13 is rotatably supported by the housing 12. The throttle valve 2 is rotatable integrally with the shaft 13 to adjust an opening degree (a cross-sectional area) of the intake passage 11. The electric actuator 1 drives the throttle valve 2 through the shaft 13.

The electric actuator 1 includes an electric motor 3, a speed-reducing-gear device 4, a spring device (also referred to as an urging force generating device) 14 and a rotational angle sensor 15. The electric motor 3 generates a rotational force (rotational torque) upon energization thereof. The speed-reducing-gear device 4 amplifies the rotational force outputted from the electric motor 3 and drives the shaft 13 with the amplified rotational force. The spring device 14 generates a spring force, i.e., an urging force to return the shaft 13 (together with the throttle valve 2) to a predetermined rotational position (a predetermined opening degree of the throttle valve 2). The rotational angle sensor 15 senses a rotational angle of the shaft 13 (the opening degree of the throttle valve 2).

Next, the above-described components will be more specifically described.

The housing 12 is a passage member (a bore housing) made of a metal material or a resin material. Bolt receiving holes are formed at an outer peripheral portion of the housing 12 to fix the electronic throttle apparatus 100 to a corresponding component with bolts installed in the bolt receiving holes, respectively, of the housing 12.

The intake passage 11, which is configured into a cylindrical tubular form, more specifically the portion of the intake passage 11, which is connected to the engine, is formed in an inside of the housing 12.

A shaft receiving hole, which receives the shaft 13, is formed in the housing 12. The shaft 13 is installed to the housing 12 such that the shaft 13 extends across the intake passage 11 in a direction, which is perpendicular to a flow direction of the air in the intake passage 11, i.e., which is perpendicular to a direction of a central axis of the intake passage 11 in the inside of the housing 12.

A plain bearing (a metal bush) 16, which rotatably supports the shaft 13, is installed in a portion of the shaft receiving hole, into which a distal end portion (a left end portion in FIG. 1) of the shaft 13 is inserted.

Furthermore, a rolling bearing (a ball bearing) 17, which rotatably supports the shaft 13, is installed in another portion of the shaft receiving hole, into which a proximal end portion (a right end portion in FIG. 1) of the shaft 13 is inserted.

The shaft 13 is made of a metal material and is configured into a generally cylindrical rod form. The shaft 13 is inserted in the intake passage 11 and is rotatable integrally with the throttle valve 2. The shaft 13 is rotatably supported by the housing 12 through the plain bearing 16 and the rolling bearing 17, as discussed above.

The throttle valve 2 is a rotatable valve of a butterfly type (also simply referred to as a butterfly valve), which is made of a metal material or a resin material and is configured into a generally circular disk form. The throttle valve 2 is fixed to the shaft 13 with one or more fixtures (e.g., one or more screws) 18 or is fixed to the shaft 13 by swaging (plastic deformation) or bonding.

The electric actuator 1 is installed to the housing 12 discussed above. Specifically, the electric motor 3 is received in a motor receiving chamber 21 formed in the housing 12. Furthermore, the speed-reducing-gear device 4 and the spring device 14 are received in a space, which is formed by the housing 12 and a cover 22. The cover 22 is detachably installed to the housing 12 with one or more fixtures (e.g., one or more screws).

A rotational direction of the electric motor 3 is switchable between a normal rotational direction and a reverse rotational direction, which are opposite to each other, by switching a flow direction of an electric current supplied to coils of the electric motor 3. The electric motor 3 is formed as a direct current motor of a known type, which generates a rotational torque (rotational force) according to the amount of electric power supplied to the electric motor 3. After the installation of the electric motor 3 into the motor receiving chamber 21, the electric motor 3 is fixed to the housing 12 with one or more fixtures (e.g., one or more screws).

The speed-reducing-gear device 4 reduces a speed of the rotation outputted from the electric motor 3 through a plurality of gears and outputs the rotation of the reduced speed (amplified rotational force) to the shaft 13. The gears of the speed-reducing-gear device 4 are arranged to amplify the rotational force received from the electric motor 3 and include a motor gear (pinion gear) 23, an intermediate gear 24 and a final gear (a gear rotor) 5. The motor gear 23 is rotatable integrally with an output shaft of the electric motor 3. The intermediate gear 24 is rotated by the motor gear 23. The final gear 5 is rotated by the intermediate gear 24. The final gear 5 is rotatable integrally with the shaft 13.

The motor gear 23 is an externally toothed gear that is fixed to the output shaft of the electric motor 3 and has a small outer diameter.

The intermediate gear 24 is a dual gear, which has a large diameter gear 24a and a small diameter gear 24b that are coaxially formed together. The intermediate gear 24 is rotatably supported by a support shaft 25 that is supported by the housing 12 and the cover 22. The large diameter gear 24a is always engaged with the motor gear 23, and the small diameter gear 24b is always engaged with the final gear 5.

The final gear 5 is an externally-toothed gear, which has a large diameter (i.e., a diameter larger than the diameter of the small diameter gear 24b) and into which a fixation plate 26 is inserted. The fixation plate 26 is fixed to the end portion of the shaft 13 by swaging (plastic deformation). The rotational torque of the electric motor 3 is transmitted through the motor gear 23, the large diameter gear 24a, the small diameter gear 24b and the final gear 5 in this order, so that the rotational torque is amplified by reducing the speed of the rotation and is finally conducted to the shaft 13. A specific example of the final gear 5 will be described later.

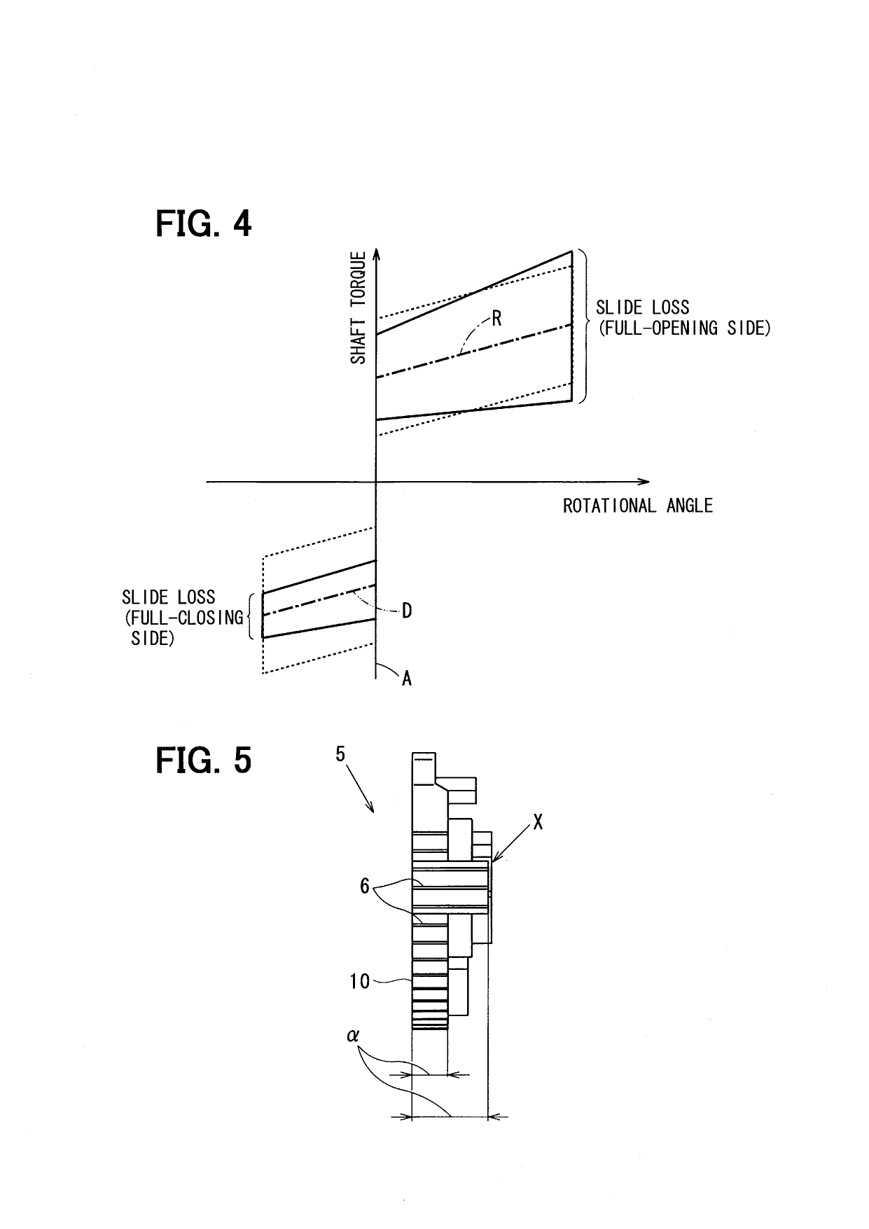

The spring device 14 returns the throttle valve 2 (more specifically, the opening degree of the throttle valve 2) to an intermediate position (see a rotational angle A shown in FIG. 4) between a full-closing position (a position where the opening degree of the throttle valve is relatively small) and a full-opening position (a position where the opening degree of the throttle valve is relatively large) of the throttle valve 2 upon stopping (interrupting) of the supply of the electric current to the electric motor 3, so that the vehicle can be driven with the engine in a limp-home-mode. The spring device 14 includes a return spring 14a and a default spring 14b. The return spring 14a exerts an urging force (a valve closing force) against the throttle valve 2 through the shaft 13 in a direction of closing the throttle valve 2. The default spring 14b exerts an urging force (a valve opening force) against the throttle valve 2 through the shaft 13 in a direction of opening the throttle valve 2. A dotted line R of FIG. 4 indicates a shaft torque (a spring torque), which is applied from the return spring 14a against the shaft 13, relative to the rotational angle of the shaft 13. Furthermore, a dotted line D of FIG. 4 indicates a shaft torque (a spring torque), which is applied from the default spring 14b against the shaft 13, relative to the rotational angle of the shaft 13.

The rotational angle sensor 15 is a throttle position sensor that senses the rotational angle of the shaft 13 to sense the opening degree (rotational angle) of the throttle valve 2. The rotational angle sensor 15 outputs an opening degree signal, which corresponds to the opening degree of the shaft 13 (the opening degree of the throttle valve 2), to an engine control unit (ECU).

Specifically, the rotational angle sensor 15 is a contactless magnetic sensor, which senses the relative rotation between two members in a contactless manner. The rotational angle sensor 15 includes a magnetic circuit 27 and two Hall ICs (magnetic sensing devices) 20. The magnetic circuit 27 is configured into a generally tubular form. The magnetic circuit 27 is inserted into an inside of the final gear 5 to rotate integrally with the shaft 13. The magnetic circuit 27 generates a change in a magnetic flux in conformity with the rotational angle of the shaft 13 at a radially inner side of the magnetic circuit 27. The Hall ICs 20 are installed to the cover 22 and are positioned relative to the magnetic circuit 27 without making a contact with the magnetic circuit 27. A voltage signal (an output signal), which is generated from the Hall ICs 20, is supplied to the ECU.

The ECU is an electronic control device of a known type, which includes a microcomputer. The ECU executes a feedback control operation of the electric motor 3 such that an actual valve opening degree of the throttle valve 2, which is sensed with the rotational angle sensor 15, coincides with a target opening degree that is set based on, for example, an opening degree of an accelerator (e.g., the amount of depression of an accelerator pedal).

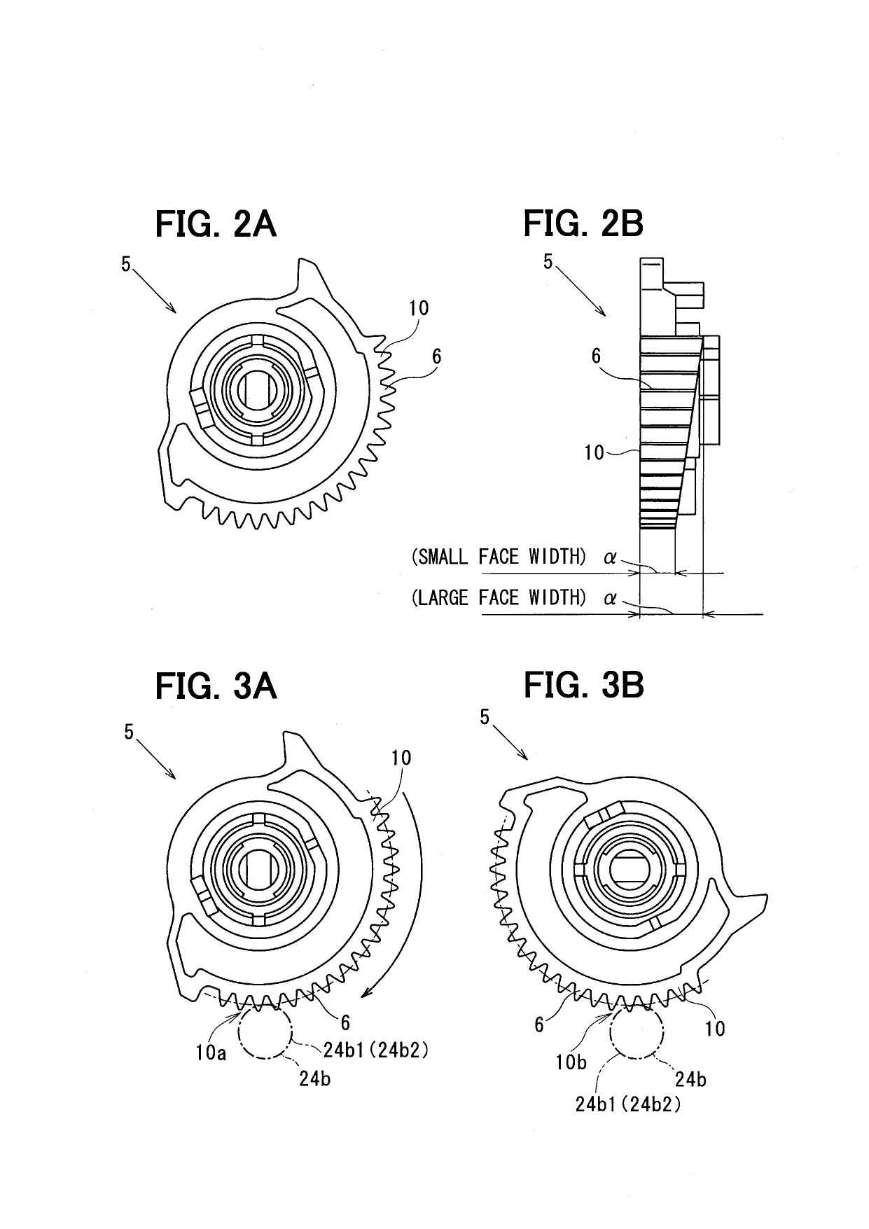

Now, the final gear 5, which is installed in the speed-reducing-gear device 4 of the electric actuator 1, will be described in detail with reference to FIGS. 2A to 4. The final gear 5 of the present embodiment serves as a subject gear (a subject gear among the plurality of gears 23, 24a, 24b, 5 of the speed-reducing-gear device 4) of the present disclosure.

The final gear 5 is a resin-molded product that is formed by insert molding the fixation plate 26, which is fixed to the end portion of the shaft 13, and the magnetic circuit 27. As shown in FIG. 2A, the final gear 5 has a plurality of external teeth 6, which are circumferentially placed one after another only in a toothed section 10 of the final gear 5. The toothed section 10 of the final gear 5 only partially extends along an outer peripheral edge of the final gear 5, i.e., only partially extends in a circumferential extent (angular extent) of the final gear 5. More specifically, the angular extent of the toothed section 10 corresponds to a rotatable range of the final gear 5, which corresponds to a rotatable range of the throttle valve 2. The small diameter gear 24b has a plurality of external teeth 24b2 (see FIG. 1), which are circumferentially placed one after another in a toothed section 24b1 of the small diameter gear 24b that extends along an entire circumferential extent of the small diameter gear 24b. The external teeth 6 of the final gear 5 are engaged with the external teeth 24b2 of the small diameter gear 24b.

A face width α of the external teeth 6 of the final gear 5, which is measured in an axial direction (a direction of a rotational axis) of the final gear 5, is set to vary in the rotational direction (circumferential direction) of the final gear 5.

In one specific example of the final gear 5, the external teeth 6 of the final gear 5 are configured as follows. Specifically, corresponding respective ones of the external teeth 6, which are located in one area of the toothed section 10 of the final gear 5 that is normally used in a small vibration state of the vehicle (i.e., an operational state of the vehicle, in which a level of the vibration of the vehicle is relatively small), have a relatively small face width(s) α. Furthermore, other corresponding respective ones of the external teeth 6, which are located in another area of the toothed section 10 of the final gear 5 that is normally used in a large vibration state of the vehicle (i.e., another operational state of the vehicle, in which the level of the vibration of the vehicle is relatively large), have a relatively large face width(s) α. In other words, the face width α is equal to or smaller than a predetermined value in the one area of the toothed section 10 of the final gear 5, which is used, i.e., is engaged with the toothed section 24b1 of the small diameter gear 24b in the state where the level of vibration of the vehicle is equal to or smaller than a predetermined level. Furthermore, the face width α is larger than the predetermined value in the other area of the toothed section 10 of the final gear 5, which is used, i.e., is engaged with the toothed section 24b1 of the small diameter gear 24b in the other state where the level of the vibration of the vehicle is larger than the predetermined level.

More specifically, with reference to FIG. 3A, the corresponding respective ones of the external teeth 6, which are engaged with the corresponding teeth 24b2 of the small diameter gear (serving as a mating gear) 24b and are located in the one area (hereinafter referred to as a throttle-full-closing position area) 10a of the toothed section 10, have the relatively small face width(s) α. The throttle-full-closing position area 10a of the toothed section 10 may be defined as an area of the toothed section 10, which engages the toothed section 24b1 of the small diameter gear 24b to position the final gear 5 and the throttle valve 2 in the throttle-full-closing position where the vibration of the vehicle is relatively small (i.e., the level of the vibration of the vehicle being equal or smaller than the predetermined level). Therefore, a contact surface area of each corresponding one of the external teeth 6, which contacts a corresponding one of the teeth 24b2 of the small diameter gear 24b, is reduced to reduce or minimize the slide loss at the contact between the external tooth 6 of the final gear 5 and the corresponding one of the teeth 24b2 of the small diameter gear 24b, which contact with each other, as indicated in the left side of FIG. 4.

With reference to FIG. 3B, the other corresponding respective ones of the external teeth 6, which are engaged with the corresponding teeth 24b2 of the small diameter gear (the mating gear) 24b and are located in the other area (hereinafter referred to as a throttle-full-opening position area) 10b of the toothed section 10, have the relatively large face width(s) α. The throttle-full-opening position area 10b of the toothed section 10 may be defined as an area of the toothed section 10, which engages the toothed section 24b1 of the small diameter gear 24b to position the final gear 5 and the throttle valve 2 in the throttle-full-opening position where the vibration of the vehicle is relatively large (i.e., the level of the vibration of the vehicle being larger than the predetermined level). Therefore, a contact surface area of each corresponding one of the external teeth 6, which contacts a corresponding one of the teeth 24b2 of the small diameter gear 24b, is increased to increase the slide loss at the contact between the external tooth 6 of the final gear 5 and the corresponding one of the teeth 24b2 of the small diameter gear 24b, which contact with each other, as indicated in the right side of FIG. 4. However, in such a case, wearing at the contact between the external tooth 6 of the final gear 5 and the corresponding one of the teeth 24b2 of the small diameter gear 24b can be limited. Here, for illustrative purpose, it should be noted that dotted lines of FIG. 4 indicate the slide loss of the prior art gear that has the external teeth, all of which has the constant face width.

Furthermore, in the present embodiment, as shown in FIG. 2B, the face width α of the external teeth 6 of the final gear 5 is progressively increased, i.e., is continuously increased one after another from the relatively small face width(s) α at the throttle-full-closing position area 10a of the toothed section 10 to the relatively large face width(s) α at the throttle-full-opening position area 10b of the toothed section 10.

A face width of the respective teeth 24b2 of the small diameter gear (the mating gear) 24b, which are engaged with the external teeth 6 of the final gear 5, is generally the same as a maximum face width α of the external teeth 6 of the final gear 5 or is larger than the maximum face width α of the external teeth 6 of the final gear 5.

Now, advantages of the first embodiment will be described.

In the first embodiment, the principle of the present disclosure is applied to the final gear 5 of the speed-reducing-gear device 4 installed in the electronic throttle apparatus 100. Furthermore, the corresponding respective ones of the external teeth 6, which are engaged with the corresponding teeth 24b2 of the small diameter gear (the mating gear) 24b and are located in the corresponding area of the toothed section 10 (the area of the toothed section 10, which engages the small diameter gear 24b to place the final gear 5 and the throttle valve 2 in the position where the opening degree of the throttle valve 2 is relatively small), have the relatively small face width(s) α. In contrast, the other corresponding respective ones of the external teeth 6, which are engaged with the corresponding teeth 24b2 of the small diameter gear (the mating gear) 24b and are located in the other corresponding area of the toothed section 10 (the area of the toothed section 10, which engages the small diameter gear 24b to place the final gear 5 and the throttle valve 2 in the position where the opening degree of the throttle valve 2 is relatively large), have the relatively large face width(s) α.

With the above construction, in the operational state where the rotational speed of the engine is relatively low (e.g., at the time of operating the engine at an idling speed), the final gear 5 is engaged with the small diameter gear (the mating gear) 24b through the corresponding external teeth 6 of the final gear 5, each of which has the corresponding small face width α. Therefore, it is possible to reduce or minimize the slide loss (gear mesh loss) at the contact between the external tooth 6 of the final gear 5 and the corresponding one of the teeth 24b2 of the small diameter gear (the mating gear) 24b, which contact with each other. Thereby, the control accuracy of the throttle valve 2 can be improved, and thereby the accuracy of idling of the engine can be improved to improve the fuel consumption.

Furthermore, with the above construction, in the operational state where the vibration (the vibration conducted to the electronic throttle apparatus 100) of the vehicle is relatively large, the final gear 5 is engaged with the small diameter gear (the mating gear) 24b through the corresponding external teeth 6 of the final gear 5, each of which has the corresponding large face width α. Therefore, the contact surface area of these external teeth 6, each of which contacts the corresponding one of the teeth 24b2 of the small diameter gear (the mating gear) 24b, is increased, and the wearing at the contact between the external tooth 6 of the final gear 5 and the corresponding one of the teeth 24b2 of the small diameter gear (the mating gear) 24b can be limited for a long period of time. Therefore, the reliability of the electronic throttle apparatus 100 can be improved for the long period of time.

### Second Embodiment

A second embodiment of the present disclosure will be described with reference to FIG. 5. In the following embodiments, components, which are similar to those of the first embodiment, will be indicated by the same reference numerals.

In the first embodiment, the face width α of the external teeth 6 of the final gear 5 is progressively increased, i.e., is continuously increased one after another from the throttle-full-closing position area of the toothed section 10 to the throttle-full-opening position area of the toothed section 10. Alternatively, the face width α of the external teeth 6 of the final gear 5 may be increased stepwise from the one circumferential side of the final gear 5 to the other circumferential side of the final gear 5 in the toothed section 10 (e.g., the throttle-full-closing position area of the toothed section 10 to the throttle-full-opening position area of the toothed section 10) by two steps. Further alternatively, the face width α of the external teeth 6 of the final gear 5 may be increased stepwise from the one circumferential side of the final gear 5 to the other circumferential side of the final gear 5 in the toothed section 10 (e.g., the throttle-full-closing position area of the toothed section 10 to the throttle-full-opening position area of the toothed section 10) by three or more steps.

FIG. 5 shows a specific example of the above construction of the second embodiment. Specifically, as shown in FIG. 5, only the corresponding respective ones of the external teeth 6, which are located in the corresponding engaging area (the throttle-full-opening position area X) of the toothed section 10 of the final gear 5 to engage with the corresponding ones of the teeth 24b2 of the small diameter gear (the mating gear) 24b in the full-opening degree of the throttle valve 2, have a large face width α, and other remaining ones of the external teeth 6, which are located in the remaining areas of the toothed section 10 of the final gear 5 that are other than the throttle-full opening position area X, have a small face width α, which is smaller than the large face width α, more specifically which is equal to or smaller than a predetermined value.

With the above construction, the wearing resistance of the external teeth 6 in the engaging area (the throttle-full-opening position area X) of the toothed section 10 of the final gear 5 can be improved.

### Third Embodiment

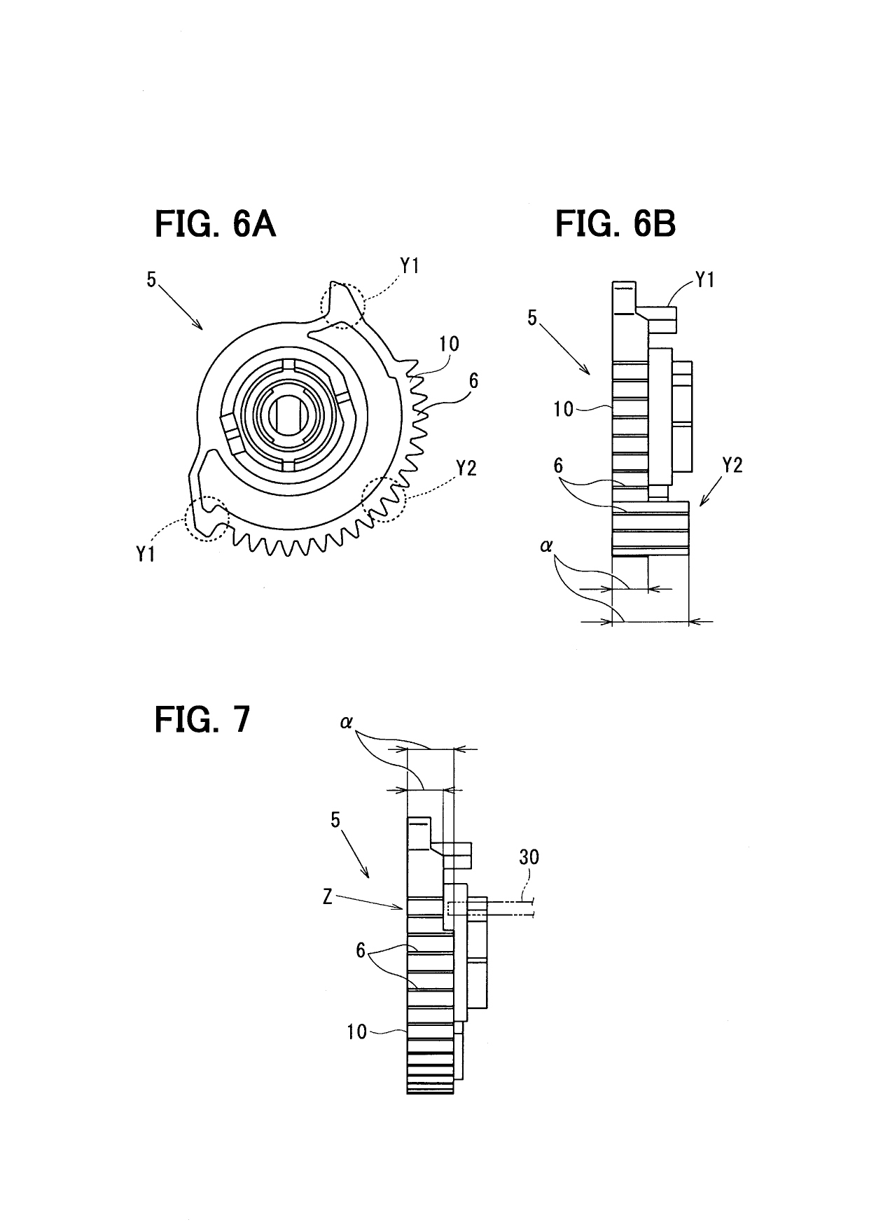

A third embodiment of the present disclosure will be described with reference to FIGS. 6A and 6B.

In the third embodiment, as shown in FIGS. 6A and 6B, two weight portions Y1 (e.g., radial or axial projections), which form, for example, stoppers, are provided in the outer peripheral portion of the final gear 5 besides the external teeth 6 (i.e., besides the toothed section 10). The weight portions Y1 are located on one circumferential side and the other circumferential side, respectively, of the toothed section 10 in the final gear 5. Due to the presence of the weight portions Y1, the weight balance of the final gear 5 about the rotational axis (the center axis of the shaft 13) of the final gear 5 is unbalanced.

In order to address such a disadvantage, according to the present embodiment, the weight balance of the final gear 5 is balanced (i.e., the level of the weight balance is adjusted to a predetermined level) by changing the face width α of the external teeth 6 in the rotational direction. Specifically, in this embodiment, as shown in FIG. 6B, the face width α of the corresponding respective external teeth 6, which are located in an area Y2 of the toothed section 10 that is chosen to alleviate the unbalance caused by the presence of the weight portions Y1, is made large, and the other remaining external teeth 6, which are located in the remaining areas of the toothed section 10, have the relatively small face width α, which is smaller than the large face width α, more specifically which is equal to or smaller than a predetermined value. Thereby, the weight balance of the final gear 5 is balanced, i.e., the level of the weight balance of the final gear 5 is improved. In the case of FIGS. 6A and 6B, the area Y2 is located in a circumferential intermediate area of the toothed section 10, which is circumferentially placed between the two weight portions Y1.

### Fourth Embodiment

A fourth embodiment of the present disclosure will be described with reference to FIG. 7.

In an imaginary case where the face width α of the external teeth 6 is made large throughout the entire circumferential extent of the toothed section 10 to improve the wearing resistance of the external teeth 6 of the final gear 5, the external teeth 6 may possibly interfere with another component of the electronic throttle apparatus 100 at the time of rotating the final gear 5.

In order to address such a disadvantage, according to the present embodiment, the face width α of the external teeth 6 is set as follows. Specifically, as shown in FIG. 7, the external teeth 6 have the large face width α except an interfering area Z of the toothed section 10, at which the external teeth 6 would interfere with another component 30 of the electronic throttle apparatus 100 at the time of rotating the final gear 5 in the imaginary case where the external teeth 6 have the large face width α in the interfering area Z.

In other words, in this instance, the component 30 axially extends into an axial extent of the large face width α that is set in the rest of the toothed section 10, which is other than the interfering area Z, and the face width α is equal to or smaller than a predetermined value in the interfering area Z of the toothed section 10 to avoid interference with the component 30, which is placed adjacent to the final gear 5, upon rotation of the final gear 5. The face width α is larger than the predetermined value in the rest of the toothed section 10 that is other than the interfering area Z and includes another area of the toothed section 10, which is engaged with the small diameter gear 24b in a state where the throttle valve 2 is placed in the throttle-full-opening position to maximize the quantity of the intake air conducted through the intake passage 11. The interfering area Z may be defined as a predetermined circumferential extent of the corresponding area of the toothed section 10, into which the component 30 enters upon rotation of the final gear 5. The axial extent of the component 30 does not overlap with an axial extent of the area Z (the axial extent of the small face width α) of the toothed section 10, and the axial extent of the component 30 overlaps with the axial extent (the axial extent of the large face width α) of the rest of the toothed section 10.

With the above construction of the present embodiment, the external teeth 6 in the interfering area Z have the relatively small face width α, which is equal to or smaller than a predetermined value and is smaller than the large face width α of the remaining area of the toothed section 10 that is other than the interfering area Z, so that the interference with the component 30 can be avoided. With this construction, except the external teeth 6, which have the small face width α and are located in the interfering area Z, the external teeth 6 of the final gear 5, which have the large face width α, can be advantageously engaged with the corresponding teeth 24b2 of the small diameter gear (the mating gear) 24b. Thereby, the wearing resistance of the final gear 5 can be improved.

### Fifth Embodiment

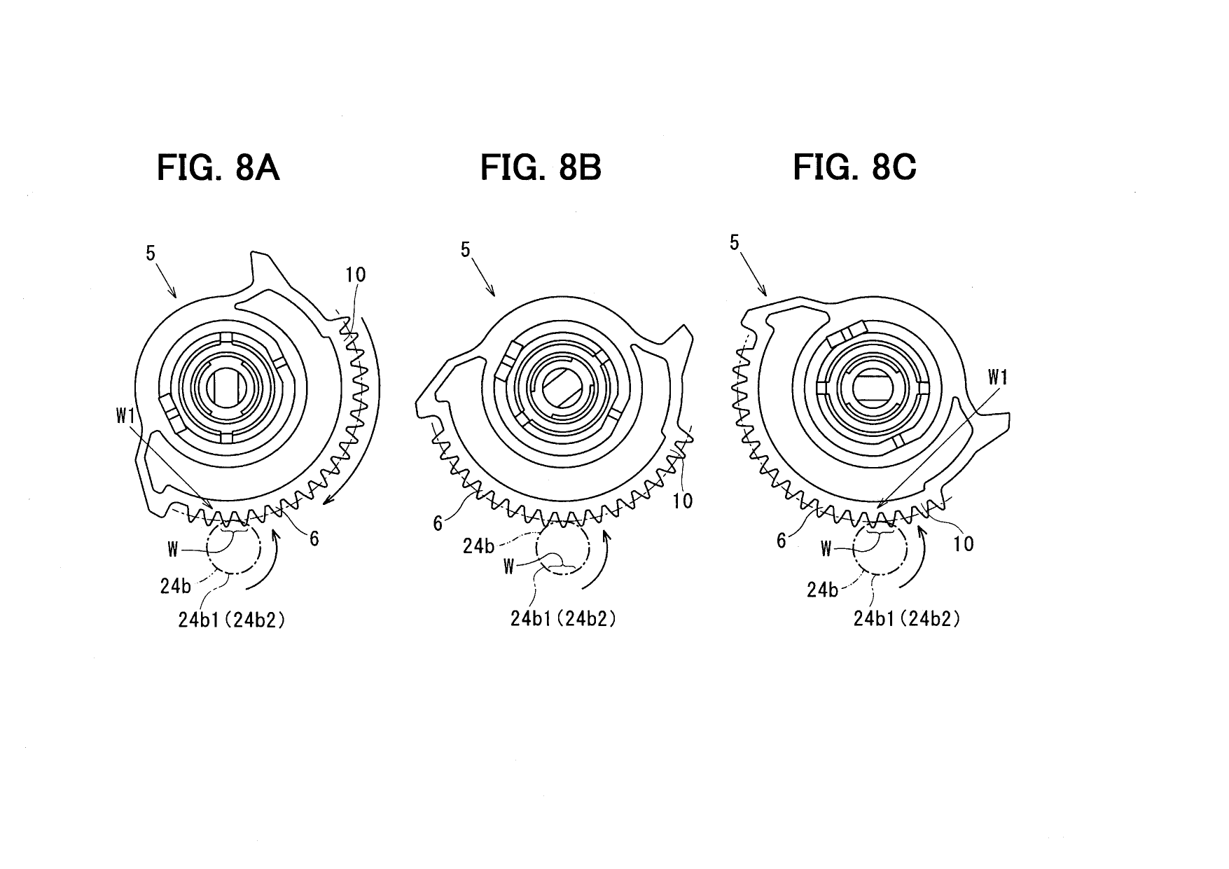

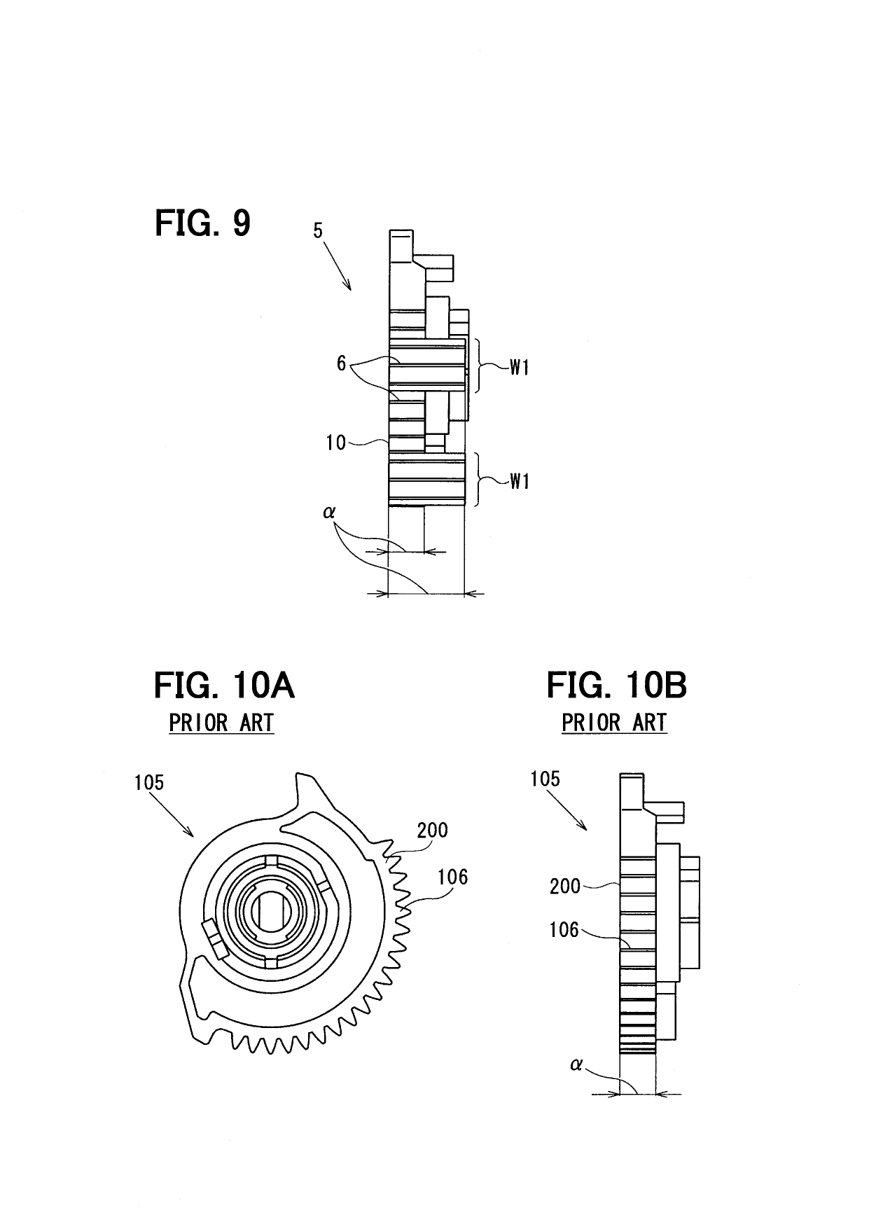

A fifth embodiment of the present disclosure will be described with reference to FIGS. 8A to 9.

As shown in FIGS. 8A to 8C, the small diameter gear (the example of the mating gear) 24b has a predetermined area (also referred to as a twice-engageable area) W in the toothed section 24b1. The predetermined area W of the small diameter gear 24b is engaged with the external teeth 6 twice when the final gear 5 is rotated throughout the entire rotatable range of the final gear 5 (e.g., from the throttle-full-closing position of the final gear 5 shown in FIG. 8A to the throttle-full-opening position of the final gear 5 shown in FIG. 8C).

The predetermined area W of the toothed section 24b1 of the small diameter gear 24b will have the greater number of times of engaging with the external teeth 6 of the final gear 5 in comparison to the rest of the toothed section 24b1 of the small diameter gear 24b.

Therefore, in a case where the face width α of the external teeth 6 of the final gear 5 in each of two areas (first and second areas) W1 of the toothed section 10, which are engageable with the predetermined area W of the small diameter gear 24b upon rotation of the final gear 5 throughout the rotatable range of the final gear 5, is small, localized wearing may possibly occur at the predetermined area W.

Therefore, in the present embodiment, as shown in FIG. 9, the face width α of the corresponding respective external teeth 6 at each of the two areas W1 of the toothed section 10, which are engageable with the predetermined area W of the small diameter gear 24b, is made larger than the face width α of the other remaining areas of the toothed section 10 of the final gear 5, i.e., is made larger than the small face width α of the other remaining areas of the toothed section 10, which is equal to or smaller than a predetermined value.

In this way, the engaging load at the predetermined area W of the small diameter gear 24b can be limited, and thereby it is possible to limit the wearing at the predetermined area W, which has the greater number of times of engaging with the external teeth 6 of the final gear 5.

It should be understood that the face width of the predetermined area W of the small diameter gear 24b may be effectively made larger than that of the remaining rotatable range of the small diameter gear 24b, which is other than the predetermined area W.

Now, modifications of the above embodiments will be described.

In the above embodiments, the principle of the present disclosure is applied to the final gear 5 of the speed-reducing-gear device 4. However, the application of the principle of the present disclosure is not limited to the final gear 5. That is, the principle of the present disclosure may be applied to any other appropriate gear, such as the large diameter gear 24a of the intermediate gear 24.

In the above embodiments, the principle of the present disclosure is applied to the gear (the final gear 5 in the embodiments) made of the resin material. However, the material of the gear of the present disclosure is not limited to any particular one. For instance, the principle of the present disclosure may be applied to a gear made of, for example, a metal material.

In the above embodiments, the principle of the present disclosure is applied to the electric actuator 1, which drives the throttle valve 2. Alternatively, the principle of the present disclosure may be applied to any other appropriate electric actuator of the vehicle that drives a subject, such as an EGR valve, which is different from the throttle valve 2.

Additional advantages and modifications will readily occur to those skilled in the art. The present disclosure in its broader terms is therefore not limited to the specific details, representative apparatus, and illustrative examples shown and described.

What is claimed is:

1. An electric actuator for a vehicle, comprising:
an electric motor that generates a rotational force upon energization of the electric motor; and
a speed-reducing-gear device that includes a plurality of gears, which are arranged to amplify the rotational force received from the electric motor, wherein a face width of a plurality of external teeth, which are circumferentially placed one after another in a toothed section of at least one subject gear among the plurality of gears, varies in a rotational direction of the at least one subject gear, and the face width is measured in an axial direction of the at least one subject gear.

2. The electric actuator according to claim 1, wherein:
the face width is equal to or smaller than a predetermined value in one area of the toothed section of the at least one subject gear, which is engaged with a toothed section of another corresponding one of the plurality of gears in a state where a level of vibration of the vehicle is equal to or smaller than a predetermined level; and
the face width is larger than the predetermined value in another area of the toothed section of the at least one subject gear, which is engaged with the toothed section of the another corresponding one of the plurality of gears in another state where the level of the vibration of the vehicle is larger than the predetermined level.

3. The electric actuator according to claim 1, wherein the face width varies in the rotational direction of the at least one subject gear to achieve a predetermined level of weight balance of the at least one subject gear.

4. The electric actuator according to claim 1, wherein:
the face width is equal to or smaller than a predetermined value in an interfering area of the toothed section of the at least one subject gear to avoid interference with another component, which is placed adjacent to the at least one subject gear, upon rotation of the at least one subject gear;
the face width is larger than the predetermined value in the rest of the toothed section of the at least one subject gear, which is other than the interfering area;
an axial extent of the another component does not overlap with an axial extent of the face width that is set in the interfering area of the toothed section of the at least one subject gear; and
the axial extent of the another component overlaps with an axial extent of the face width that is set in the rest of the toothed section of the at least one subject gear.

5. The electric actuator according to claim 1, wherein:
the at least one subject gear is engaged with another corresponding one of the plurality of gears;
the another corresponding one of the plurality of gears has a plurality of external teeth in a toothed section of the another corresponding one of the plurality of gears;
a predetermined area of the toothed section of the another corresponding one of the plurality of gears is engageable with first and second areas of the toothed section of the at least one subject gear when the at least one subject gear is rotated throughout a rotatable range of the at least one subject gear; and
the face width of each of the first and second areas of the toothed section of the at least one subject gear is larger than the face width of the rest of the toothed section of the at least one subject gear, which is other than the first and second areas of the toothed section of the at least one subject gear.

6. The electric actuator according to claim 1, wherein the speed-reducing gear device conducts the rotational force from the electric motor to a shaft that is rotatable integrally with a throttle valve, which is placed in an intake passage, to adjust an opening degree of the intake passage and thereby to adjust a quantity of intake air supplied to an internal combustion engine of the vehicle through the intake passage.

7. The electric actuator according to claim 6, wherein:
the at least one subject gear includes a final gear that is fixed to the shaft to rotate integrally with the shaft;
the face width is equal to or smaller than a predetermined value in one area of the toothed section of the final gear, which is engaged with a toothed section of another corresponding one of the plurality of gears in a state where the throttle valve is placed in a throttle-full-closing position to minimize the quantity of the intake air conducted through the intake passage; and
the face width is larger than the predetermined value in another area of the toothed section of the final gear, which is engaged with the toothed section of the another corresponding one of the plurality of gears in another state where the throttle valve is placed in a throttle-full-opening position to maximize the quantity of the intake air conducted through the intake passage.

8. The electric actuator according to claim 1, wherein:
the electric actuator is installed in an electronic throttle apparatus, which adjusts an opening degree of an intake passage that guides intake air to an internal combustion engine of the vehicle; and
the speed-reducing-gear device drives a shaft that is rotatable integrally with a throttle valve placed in an inside of the intake passage.
